(19) United States
(12) Patent Application Publication
(10) Pub. No.: US 2009/0223229 A1
(43) Pub. Date: Sep. 10, 2009

(54) Method and System for Using Low BTU Fuel Gas in a Gas Turbine

(76) Inventors: Hua Wang, Clifton Park, NY (US); Sachin Nijhawan, Atlanta, GA (US); Joseph Anthony Suriano, Clifton Park, NY (US); Neil Edwin Moe, Minnetonka, MN (US)

Correspondence Address: CANTOR COLBURN, LLP, 20 Church Street, 22nd Floor, Hartford, CT, 06103, US

(21) Appl. No.: 11/612,760

(22) Filed: Dec. 19, 2006

(51) Int. Cl. F02C 3/20; F02C 7/22

(52) U.S. Cl. 60/780; 60/39.461

(57) ABSTRACT

In one embodiment, a combustion system comprises: a fuel supply comprising a fuel having a heating value of less than or equal to about 100 Btu/scf, an inert gas sequestration unit in fluid communication with the fuel supply, and a combustion system located downstream of and in fluid communication with the inert gas sequestration unit and with an oxidant supply. The inert gas sequestration unit comprises a membrane configured to separate N₂ from CO and to form a retentate stream having a heating value of greater than or equal to about 110 Btu/scf. In one embodiment, a method for operating a power plant, comprises: passing a fuel stream through an inert gas sequestration unit to remove N₂ from the fuel stream and to form a retentate stream, and combusting the retentate stream and an oxidant stream to form a combustion stream.

### BACKGROUND

This application relates generally to a combustion system and, more particularly, to a combustion system and method for using fuels with low heating value therein.

Modern high performance power generation applications are often based upon gas turbine technology. Gas turbines are however usually designed to operate on natural gas fuel. Widespread gas pipeline interconnectivity and liquid natural gas (LNG) imports are leading to varying gas quality. Also, alternative fuel usage (for example biofuel, syngas, gasified industrial waste (e.g., black liquor from the pulp industry, residual oil from the petroleum refinery industry, and gas from the iron and steel industry (such as blast furnace gas))) is becoming a commercial necessity. Consumers will require the gas turbine equipment to operate in this new environment with minimal hardware or controls changes to accommodate the range of fuels. An important common characteristic of many of such alternative fuels is their low heating value.

Air pollution concerns worldwide have led to stricter emissions standards. These standards regulate the emission of oxides of nitrogen (NOx), unburned hydrocarbons (HC), carbon monoxide (CO), and carbon dioxide (CO₂), generated by the power industry. In particular, carbon dioxide has been identified as a greenhouse gas, resulting in various techniques being implemented to reduce the concentration of carbon dioxide being discharged to the atmosphere.

The application of syngas conversion and subsequent purification (e.g., after generation from coal gasification processes), can be used for integrated gasification combined cycle (IGCC) power plants for electricity production from coal, and IGCC-based polygeneration plants that produce multiple products such as hydrogen and electricity from coal, and is useful for other plants that include carbon dioxide separation. Purification is also applicable to other hydrocarbon-derived syngas, such as that used for electricity production or polygeneration, including syngas derived from natural gas, heavy oil, biomass and other sulfur-containing heavy carbon fuels.

Thus, methods and systems that will allow gas turbines to operate in an efficient, safe, and reliable manner utilizing a wide range of fuels while minimizing polluting emissions (e.g., carbon dioxide (CO₂ and nitrogen oxides (NOₓ) will be highly valuable and is continually sought.

### BRIEF DESCRIPTION

Disclosed herein are embodiments of a power system, and a method and system for converting a low heating value fuel to a higher heating value fuel, and methods for use thereof.

In one embodiment, a power plant comprises: a fuel supply comprising a fuel having a heating value of less than or equal to about 100 Btu/scf, an inert gas sequestration unit in fluid communication with the fuel supply, and a gas turbine engine assembly located downstream of and in fluid communication with the inert gas sequestration unit and with an oxidant supply. The inert gas sequestration unit comprises a membrane configured to separate N₂ from CO and to form a retentate stream having a heating value of greater than or equal to about 110 British thermal units per standard cubic foot (Btu/scf). The gas turbine engine assembly is configured to generate power.

In one embodiment, a combustion system comprises: a fuel supply comprising a fuel having a heating value of less than or equal to about 100 Btu/scf, an inert gas sequestration unit in fluid communication with the fuel supply, and a combustion system located downstream of and in fluid communication with the inert gas sequestration unit and with an oxidant supply. The inert gas sequestration unit comprises a membrane configured to separate N₂ from CO and to form a retentate stream having a heating value of greater than or equal to about 110 Btu/scf.

In one embodiment, a method for operating a power plant, comprises: passing a fuel stream through an inert gas sequestration unit to remove N₂ from the fuel stream and to form a retentate stream, and combusting the retentate stream and an oxidant stream to form a combustion stream. The fuel stream has a heating value of less than or equal to about 100 Btu/scf, and the retentate stream has a heating value of greater than or equal to about 110 Btu/scf.

The above described and other features are exemplified by the following figures and detailed description.

### BRIEF DESCRIPTION OF THE DRAWINGS

Refer now to the figures, which are exemplary, not limiting, and wherein like numbers are numbered alike.

FIG. 1 is a schematic illustration of an exemplary power plant with an inert gas sequestration unit.

FIG. 2 is a graphical representation of membrane permeability represented in permeated volume percent versus volume percent in the concentrate (e.g., fluid), for the zeolite membrane.

### DETAILED DESCRIPTION

Disclosed are membrane processes and membranes that can cost effectively remove inert gases (mainly N₂, and optionally CO₂) from a process fuel such as blast furnace gas, allowing for improved fuel heating value and the elimination or reduction of blending coke oven gas as fuel gas for gas turbine. The disclosed methods allow gas turbine equipment to operate with minimal turbine hardware or controls changes required to accommodate low heating value fuels. More specifically, disclosed are membrane processes and membranes for the removal of nitrogen (N₂) and optionally other inert components (e.g., CO₂) from a low heating value (e.g., low Btu) process fuel gas (e.g., less than or equal to about 90 Btu/scf), in particular, a blast furnace gas (“BFG”; a mixture of N₂, CO₂, carbon monoxide (CO), and hydrogen (H₂)), wherein the nitrogen concentration is greater than or equal to 50 volume percent (vol %)). The processes involve contacting a low Btu fuel gas feed stream with a membrane having sufficient flux and selectivity to separate it into an inert gas (e.g., N₂ and CO₂) enriched permeate fraction and an inert gas deficient retentate fraction under gas membrane separation conditions. The retentate fraction can have a substantially upgraded Btu value, e.g., greater than or equal to about 110 Btu/scf, or, more particularly, greater than or equal to about 140 Btu/scf, or, even more specifically, greater than or equal to about 180 Btu/scf. At a Btu/scf of greater than or equal to 180, the retentate fraction is suitable for gas turbines power generation applications. At the lower values, the retentate fraction can be used in gas turbine engine applications using a smaller stream of blending gas. It is also noted that this membrane technology to separate N₂/CO can also be used for other separations, such as removal of contaminants from coke oven gas to be used with Jenbacher machines.

A variety of process fuels, e.g., blast furnace gas from steel processes, air blown gasification with low quality/rank coals, and oxygen blown gasification with refinery, have a heating value that is only a fraction of that of natural gas. Blast furnace gas typically has a low heating value of about 75 Btu/scf to about 100 Btu/scf, wherein many gas turbine units use a fuel in having a heating value of about 180 to about 200 Btu/scf. For example, blast furnace gas having a composition of 55 volume percent (vol %) N₂, 20 vol % CO₂, 20 vol % CO, and 2 vol % to 3 vol % H₂ (based upon the total volume of the blast furnace gas) has a heating value of about 75 Btu/scf. Hence, in order to use this blast furnace gas in a gas turbine, it is blended with either coke oven gas, natural gas, or the like (a blending gas), in order to sufficiently increase the heating value to above 180 Btu/scf. However, removal of inert gases from of process fuels would allow for improved fuel heating value, and the reduction or even elimination of blending gas.

Gas turbine performance is significantly affected by the heating value of the fuel. Fuel flow must increase when heating value drops to provide the heat for the process, however, the compressor does not compress the additional mass flow. There are several side effects of the increased mass flow. 1) The increase in mass flow through the turbine increases the power developed by the turbine. The compressor uses some of the increase in power, resulting in an increase in the pressure ratio across the compressor, driving it closer to a surge limit. 2) The increase in turbine power could also cause the turbine and all the equipment in the power train to operate above their 100% rating. Hence, equipment rated at higher limit (e.g., more expensive equipment) maybe needed in some cases. 3) The size and cost of piping increases with increased fuel flow rate. 4) Gas with a lower heating value is normally saturated with water before delivery to the turbine, resulting in an increase in heat transfer coefficient of the combusted products, and hence an increase in the temperature of the turbine. 5) The amount of air required to burn the fuel increases as the heating value decreases. In sum, gas turbines with high firing temperatures may not able to operate with low-heating-value fuel.

Disclosed herein are membrane processes and membranes for the removal of N₂ and other inert components (e.g. CO₂) from a gas stream (e.g., a low Btu process fuel gas; a fuel gas having a heating value of less than or equal to 100 Btu/scf), and in particular, a blast furnace gas. The processes involve contacting a fuel gas feed stream with a membrane having sufficient flux and selectivity to separate the fuel gas into an inert gas (e.g., N₂ and CO₂) enriched permeate fraction and an inert gas deficient retentate fraction. As a result of the separation, the retentate fraction has a substantially upgraded heating value, and can be used directly (or with minimal blending gas) in a power plant, e.g., can be sent to a turbine as fuel for gas turbine power generation applications.

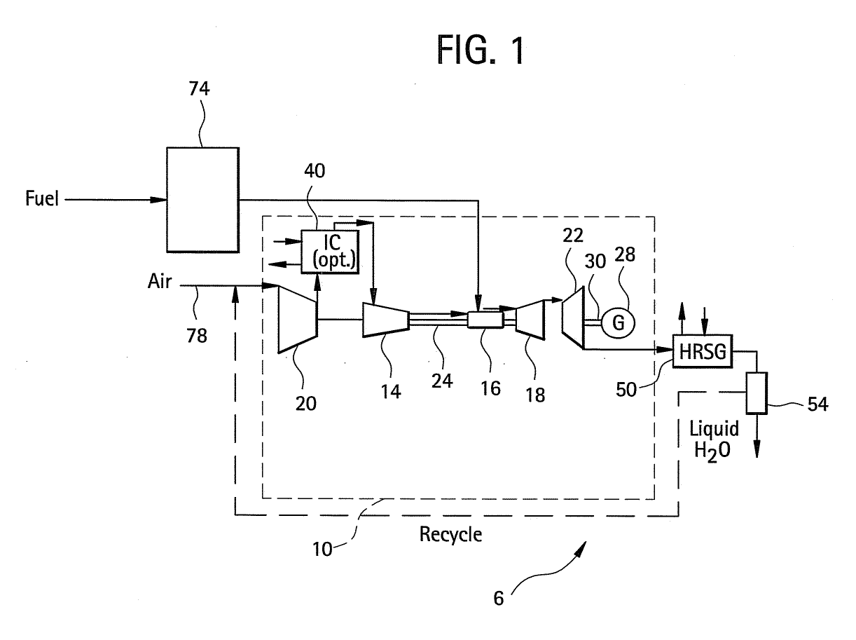

FIG. 1 is a schematic illustration of an exemplary power plant 8 that includes an exemplary gas turbine engine assembly 10. The gas turbine engine assembly receives oxidant (e.g., air), in air stream 78, while the fuel passes through inert gas (N₂, CO₂) sequestration unit 74 prior to introduction to a mixer (not shown) and the combustor 16. The inert gas sequestration unit comprises an inert gas selective membrane.

Not to be limited by theory, the transport of gases through a polymeric membrane operates by a solution-diffusion mechanism. The solution-diffusion mechanism is considered to have three steps: the capture (e.g., absorption and/or adsorption) at the upstream boundary, activated diffusion (solubility) through the membrane, and release (e.g., desorption and/or evaporation) on the downstream side. This gas transport is driven by a difference in the thermodynamic activities existing at the upstream and downstream sides of the membrane as well as the interacting force between the molecules that constitute the membrane material and the permeate molecules. The activity difference causes a concentration difference that leads to diffusion in the direction of decreasing activity. The particular membranes employed are based upon an ability to control the permeation of different species.

Again, not to be limited by theory, in the transport of gases through porous, inorganic membrane(s), several mechanism(s) may be involved in the transport of gases across a porous membrane: Knudsen diffusion, surface diffusion, capillary condensation, laminar flow, and/or molecular sieving. The relative contributions of the different mechanisms are dependent on the properties of the membranes and the gases, as well as on operating conditions like temperature and pressure. Molecular sieve membranes (such as zeolites and carbon molecular sieves) are porous and contain pores of molecular dimensions (greater than 0.5 nm), which can exhibit selectivity according to the size of the molecule.

It is noted that the permeance or thickness-normalized permeability is the gas flow rate through the membrane multiplied by the thickness of the material, divided by the area and by the pressure difference across the material. To measure this quantity, the barrer is the permeability represented by a flow rate of 10⁻¹⁰ cubic centimeters per second (volume at standard temperature and pressure, 0° C. and 1 atmosphere), times 1 centimeter of thickness, per square centimeter of area and centimeter of mercury difference in pressure. The term “membrane selectivity” or “selectivity” is the ratio of the permeabilities of two gases and is a measure of the ability of a membrane to separate the two gases. For example, selectivity of a N₂ selective membrane is the ratio of the permeability of N₂ through the membrane versus that of CO. The membranes desirably have a selectivity of greater than or equal to about 4, or, more specifically, greater than or equal to about 8, or, yet more specifically, greater than or equal to about 12.

Possible membranes include polymeric membranes (e.g., non-porous polymeric membranes, such as acrylate copolymers, maleic acid copolymers, polyimide, polysulfone, and so forth), inorganic molecular sieve (such as preferentially oriented MFI zeolite membranes), nano-porous ceramics membranes, organic/inorganic hybrid membranes such as mixed matrix membranes, facilitated membranes with transition metal ions, and membranes containing immobilized and/or crosslinked ionic liquids), as well as combinations comprising at least one of the foregoing. The membranes can be used in various forms, such as flat-sheet form that is packaged in a spiral-wound module configuration, hollow fiber form, tubular form, and so forth.

In practice, the membrane often comprises a separation layer that is disposed upon a support layer. For asymmetric inorganic membranes, the porous support can comprise a material that is different from the separation layer. Support materials for asymmetric inorganic membranes include porous alumina, titania, cordierite, carbon, silica glass (e.g., Vycor®), and metals, as well as combinations comprising at least one of these materials. Porous metal support layers include ferrous materials, nickel materials, and combinations comprising at least one of these materials, such as stainless steel, iron-based alloys, and nickel-based alloys. Polymeric membranes can be disposed on polymeric or inorganic supports. For example, a possible membrane is a B—Al-ZSM-5 zeolite membrane, prepared from B-containing porous glass disks in a mixed vapor of ethylenediamine, tri-n-propylamine, and H₂O. Not to be limited by theory, it is believed that the crystals with the orientations of {101}/{011} and {002} planes paralleling to the substrate surfaces, predominate in the membranes.

Gas turbine engine assembly 10 includes a core gas turbine engine 12 that includes a high-pressure compressor 14 (e.g., that can compress the stream to pressures of greater then or equal to about 45 bar), a combustor 16, and a high-pressure turbine 18. Gas turbine engine assembly 10 also includes a low-pressure compressor 20 (e.g., that can compress up to about 5 bar) and a low-pressure turbine 22. High-pressure compressor 14 and high-pressure turbine 18 are coupled by a first shaft 24, and low-pressure compressor 20 is connected to an intermediate pressure turbine (not shown) by a second shaft 26. In the exemplary embodiment, low-pressure turbine 22 is connected to a load, such as a generator 28 via a shaft 30. In the exemplary embodiment, core gas turbine engine 12 is an LMS100 available from General Electric Aircraft Engines, Cincinnati, Ohio.

The gas turbine engine assembly 10 can include an intercooler 40 to facilitate reducing the temperature of the compressed airflow entering high-pressure compressor 14. More specifically, intercooler 40 can be in flow communication between low-pressure compressor 20 and high-pressure compressor 14 such that airflow discharged from low-pressure compressor 20 is cooled prior to being supplied to high-pressure compressor 14.

Power plant 8 also includes a heat recovery steam generator (HRSG) 50 that is configured to receive the relatively hot exhaust stream discharged from the gas turbine engine assembly 10 and transfer this heat energy to a working fluid flowing through the HSRG 50 to generate steam which, in the exemplary embodiment, can be used to drive a steam turbine 52. A drain 54 can be located downstream from HSRG 50 to substantially remove the condensate from the exhaust stream discharged from HSRG 50. A dehumidifier (not shown) can also be employed downstream of the HRSG 50 and upstream of the drain 54, to facilitate water removal from the exhaust stream. The dehumidifier can comprise a desiccant air drying system.

The intercooler(s) (40, etc.) can, individually, be a water-to-air heat exchanger, an air-to-air heat exchanger, or the like. The water-to-air heat exchanger can have a working fluid (not shown) flowing therethrough. For example, the working fluid can be raw water that is channeled from a body of water located proximate to power plant 8 (e.g., a lake). The air-to-air heat exchanger can have a cooling airflow (not shown) flowing therethrough.

During operation, the fuel passes through the inert gas sequestration unit 74 where N₂ and optionally other inert (e.g., non-combustible) gas(es) (such as CO₂) are removed from the fuel stream. The fuel stream 76 then enters the combustor 16 where it is combusted with the air, e.g., from compressor 14.

Gas turbine engine assembly 10 produces an exhaust stream having a temperature of about 600 degrees Fahrenheit (° F.) (316 degrees Celsius (° C.)) to about 1,300° F. (704° C.). The exhaust stream discharged from gas turbine engine assembly 10 is channeled through HRSG 50 wherein a substantial portion of the heat energy from the exhaust stream is transferred to the working fluid channeled therethrough to generate steam that as discussed above, that can be utilized to drive steam turbine 52. HSRG 50 facilitates reducing the operational temperature of the exhaust stream to a temperature that is of about 75° F. (24° C.) and about 125° F. (52° C.). In the exemplary embodiment, HSRG 50 facilitates reducing the operational temperature of the exhaust stream to a temperature that is approximately 100° F. (38° C.). In one embodiment, the exhaust stream can also be channeled through additional heat exchangers (not shown) to further condense water from the exhaust stream, which water is then discharged through drain 54, for example.

It is noted that although the membrane processes and membranes for the removal of inert components have been described in relation to the power plant illustrated in FIG. 1, these membranes and processes can be used with any variation of a power plant or other system where N₂ removal from a gaseous stream is desirable. Apparatus comprising the present membranes are particularly useful where the heating value of the retentate stream is about 180 to about 200 Btu/scf after the inert gas (e.g. N₂) removal.

The following examples are provided to further illustrate the membranes and the use thereof and are not intended to limit the broad scope of this application.

### EXAMPLES

### Example 1

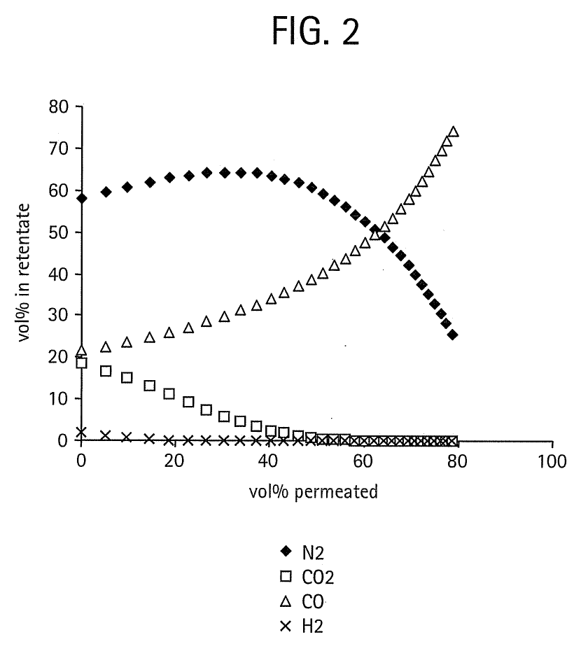

A computer calculation is performed to demonstrate the process of separating N₂ from CO in a fuel stream and according to the embodiment of FIG. 2. A raw blast furnace gas is assumed to be of the volume percent composition and heating value set forth in Table 1. The relative permeability of the zeolite membrane for nitrogen, carbon dioxide, carbon monoxide, and hydrogen, are 7.7, 41, 1, and 130, respectively.

TABLE 1
Raw Blast Furnace Gas

| Component | Composition (vol %) |
|---|---|
| Nitrogen | 58.0 |
| Carbon Dioxide | 18.5 |
| Carbon Monoxide | 21.5 |
| Hydrogen | 2.0 |
| Heating value (Btu/scf) | 75 |

Table 2 shows calculated retentate composition and heating value when this raw blast furnace gas is separated by the described zeolite membranes at different percentage recovery (ratio of permeate flow rate over feed flow rate, or volume percentage of the feed that permeates through the membrane).

TABLE 2
Retentate composition and heating value

| composition | composition (volume %) | | |
|---|---|---|---|
| (volume %) | 30% recovery | 50% recovery | 70% recovery |
| Nitrogen | 63.9 | 59.7 | 41.2 |
| Carbon Dioxide | 6.4 | 0.7 | 0 |
| Carbon Monoxide | 29.7 | 39.4 | 58 |
| Hydrogen | 0 | 0 | 0 |
| Heating value | 96 | 127 | 189 |
| (Btu/scf) | | | |

Table 2 shows that the heating value of the retentate increases with the increase of carbon monoxide concentration in the retentate as a result of the inert nitrogen and carbon dioxide permeating through the membrane. The heat value of the retentates is 96, 127, and 189 for a recovery of 30%, 50%, and 70%, respectively. In other words, with the present inert gas sequestration unit, a retentate stream can be formed having a heating value of greater than or equal to about 115 Btu/scf, or, more specifically, greater than or equal to about 130 Btu/scf, or, even more specifically, greater than or equal to about 160 Btu/scf, or, yet more specifically, greater than or equal to about 175 Btu/scf, and even more specifically, greater than or equal to about 185 Btu/scf.

### Comparative Example 1

A computer calculation is performed for a polydimethylsiloxane (PDMS) membrane. A raw blast furnace gas was assumed to be the volume percent composition in Table 1. The heating value of this raw blast furnace gas is 75 Btu/scf. The relative permeability of the PDMS membrane for nitrogen, carbon dioxide, carbon monoxide, and hydrogen, are 0.76, 6.4, 1, and 1.9, respectively.

Table 3 shows calculated retentate composition and heating value when this raw blast furnace gas is separated by the described PDMS membranes at different percentage recovery (ratio of permeate flow rate over feed flow rate, or volume percentage of the feed that permeated through the membrane).

TABLE 3
Retentate composition and heating value

| | composition (volume %) | | |
|---|---|---|---|
| component | 10% recovery | 30% recovery | 50% recovery |
| N₂ | 61.6 | 68.8 | 74.2 |
| CO₂ | 14 | 5.3 | 0.7 |
| CO | 22.5 | 24.1 | 23.9 |
| H₂ | 2 | 1.8 | 1.3 |
| Heating value | 78 | 82 | 80 |
| (Btu/scf) | | | |

Table 3 shows that the heating value of the retentate stream minimally increases in heating value. The PDMS membrane permeates carbon dioxide through and rejects nitrogen. As a result, the volume fraction of high heating value carbon monoxide in the retentate stream does not change significantly with 10%, 30%, and 50% recovery. Thus, these PDMS membranes are not useful for significantly enhancing the heating value of blast furnace gas.

### Comparative Example 2

A computer calculation is performed for a cellulose acetate (CA) membrane. A raw blast furnace gas is assumed to be of the volume percent composition in Table 1. The heating value of this raw blast furnace gas is 75 Btu/scf. The relative permeability of the CA membrane for nitrogen, carbon dioxide, carbon monoxide, and hydrogen are 0.62, 23, 1, and 50, respectively.

Table 4 shows calculated retentate composition and heating value when this raw blast furnace gas is separated by the described CA membranes at different percentage recovery (ratio of permeate flow rate over feed flow rate, or volume percentage of the feed that permeated through the membrane).

TABLE 4
Retentate composition and heating value

| | composition (volume %) | | |
|---|---|---|---|
| component | 10% recovery | 30% recovery | 50% recovery |
| N₂ | 63.6 | 74.1 | 77.6 |
| CO₂ | 12.3 | 0.3 | 0 |
| CO | 23.4 | 25.6 | 22.4 |
| H₂ | 0.7 | 0 | 0 |
| Heating value | 77 | 82 | 72 |
| (Btu/scf) | | | |

Here the heating value of the retentate stream shows minimum increase or a slight decrease in heating value at the recovery rates of 10%, 30%, and 50%. The CA membrane permeates carbon dioxide through and rejects nitrogen. As a result, the volume fraction of high heating value carbon monoxide in the retentate stream did not change significantly with 10%, 30%, and 50% recovery. Thus, these CA membranes are not useful for significantly enhancing the heating value of blast furnace gas. The present membranes and processes enable the separation of N₂ from CO in a gaseous fuel, and therefore enable the enhancement of the heat value of the fuel. If merely CO₂ is removed from a fuel (e.g., blast furnace gas), the heat value increases by less than 10 Btu/scf. However, the removal of N₂ from the blast furnace gas increases the heat value by greater than or equal to about 40 Btu/scf, or, more specifically, by greater than or equal to about 60 Btu/scf, or, even more specifically, by greater than or equal to about 80 Btu/scf, and yet more specifically, by greater than or equal to about 100 Btu/scf. The membranes enable the separation of N₂ from CO so the CO concentration in the retentate stream is greater than or equal to about 35 vol %, or, more specifically, greater than or equal to about 45 vol %, even more specifically, greater than or equal to about 55 vol %, based upon a total volume of the retentate stream.

Ranges disclosed herein are inclusive and combinable (e.g., ranges of “up to about 25 vol %, or, more specifically, about 5 vol % to about 20 vol %”, is inclusive of the endpoints and all intermediate values of the ranges of “about 5 vol % to about 25 vol %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and can or can not be present in other embodiments. In addition, it is to be understood that the described elements can be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to a preferred embodiment, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A power plant, comprising:
a fuel supply comprising a fuel having a heating value of less than or equal to about 100 Btu/scf,
an inert gas sequestration unit in fluid communication with the fuel supply, wherein the inert gas sequestration unit comprises a membrane configured to separate N₂ from CO and to form a retentate stream having a heating value of greater than or equal to about 110 Btu/scf,
a gas turbine engine assembly downstream of and in fluid communication with the inert gas sequestration unit and with an oxidant supply, wherein the gas turbine engine assembly is configured to generate power.

2. The power plant of claim 1, wherein the gas turbine engine assembly further comprises
a compressor downstream of and in fluid communication with the oxidant supply;
a combustor downstream of and in fluid communication with the compressor and with the inert gas sequestration unit; and
a turbine downstream of and in fluid communication with the combustor.

3. The power plant of claim 1, wherein the membrane is selected from the group consisting of a polymeric membrane, an inorganic molecular sieve, a nano-porous ceramic membrane, an organic/inorganic hybrid membrane, a facilitated membrane comprising a transition metal ion, a membrane comprising immobilized and/or crosslinked ionic liquid, and combinations comprising at least one of the foregoing.

4. The power plant of claim 3, wherein the polymeric membrane comprises a polymer selected from the group consisting of an acrylate copolymer, a maleic acid copolymer, a polyimide, a polysulfone, and combinations comprising at least one of the foregoing.

5. The power plant of claim 3, wherein the inorganic molecular sieve comprises an MFI zeolite membrane.

6. The power plant of claim 3, wherein the organic/inorganic hybrid membrane comprises a mixed matrix membrane

7. The power plant of claim 3, wherein the membrane comprises a crosslinked ionic liquid.

8. The power plant of claim 3, wherein the membrane comprises an immobilized ionic liquid.

9. The power plant of claim 1, wherein the membrane configured to form a retentate stream having a heating value of greater than or equal to about 140 Btu/scf.

10. The power plant of claim 9, wherein the membrane configured to form a retentate stream having a heating value of greater than or equal to about 180 Btu/scf.

11. The power plant of claim 1, wherein the membrane has a N₂/CO selectivity of greater than or equal to about 4.

12. The power plant of claim 11, wherein the membrane has a N₂/CO selectivity of greater than or equal to about 8.

13. The power plant of claim 12, wherein the membrane has a N₂/CO selectivity of greater than or equal to about 12.

14. A combustion system, comprising:
a fuel supply comprising a fuel having a heating value of less than or equal to about 100 Btu/scf,
an inert gas sequestration unit in fluid communication with the fuel supply, wherein the inert gas sequestration unit comprises a membrane configured to separate N₂ from CO and to form a retentate stream having a heating value of greater than or equal to about 110 Btu/scf; and
a combustion system located downstream of and in fluid communication with the inert gas sequestration unit and with an oxidant supply.

15. The system of claim 14, wherein the combustion system comprises:
a compressor downstream of and in fluid communication with the oxidant supply;
a combustor downstream of and in fluid communication with the compressor and with the inert gas sequestration unit; and
a turbine downstream of and in fluid communication with the combustor.

16. A method for operating a power plant, comprising:
passing a fuel stream through an inert gas sequestration unit to remove N₂ from the fuel stream and to form a retentate stream, wherein the fuel stream has a heating value of less than or equal to about 100 Btu/scf, and the retentate stream has a heating value of greater than or equal to about 110 Btu/scf; and
combusting the retentate stream and an oxidant stream to a combustion stream.

17. The method of claim 16, further comprising
prior to combusting, compressing the oxidant stream; and
passing the combustion stream through a turbine.

18. The method of claim 16, wherein the retentate heating value is greater than or equal to about 140 Btu/scf.

19. The method of claim 18, wherein the retentate heating value is greater than or equal to about 180 Btu/scf.

20. The method of claim 16, further comprising, prior to combusting, combining the retentate stream with a bleed stream to increase the retentate heating value to greater than or equal to about 180 Btu/scf.
